(19) United States
(12) Patent Application Publication
(10) Pub. No.: US 2021/0270488 A1
(43) Pub. Date: Sep. 2, 2021

(54) VENDOR-AGNOSTIC ATTRIBUTE CLONING

(71) Applicant: Johnson Controls Technology Company, Auburn Hills, MI (US)

(72) Inventors: Sandip Salunke, Panchavati (IN); Mark Fischbach, New Berlin, WI (US); Vivek V. Gupta, Menomonee Falls, WI (US)

(73) Assignee: Johnson Controls Technology Company, Auburn Hills, MI (US)

(21) Appl. No.: 16/805,598

(22) Filed: Feb. 28, 2020

(51) Int. Cl. F24F 11/58; F24F 11/49; G05B 19/418

(52) U.S. Cl. CPC F24F 11/58; G05B 19/4185; F24F 11/49

(57) ABSTRACT

A building management system includes a processing circuit configured to clone the configuration of a first device to one or more devices in a network. The building management system may be configured to determine the source device and the one or more destination devices, retrieve the configuration data from the source device, determine a configuration of the second device, determine a mapping of the source device configuration to the destination device configuration, and send one or more commands to the destination devices to configure the destination devices with properties from the source device configuration. The cloning method may thus be used to clone devices remotely, where the devices can be from different vendors or be different models and located at different locations.

### BACKGROUND

The present disclosure relates generally to building management systems. The present disclosure relates more particularly to cloning attributes for building control systems.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include VERASYS® building controllers or other devices sold by Johnson Controls, Inc., as well as building devices, controllers, and components from other sources.

### SUMMARY

Various embodiments of the present disclosure relate to a building system configured to copy a configuration of a first controller to a second controller. The building system includes a processing circuit configured to receive a first instruction to copy the configuration of the first controller to the second controller, retrieve the configuration of the first controller, determine a mapping of the first set of properties to a second set of properties associated with the second controller, and send a command to the second controller. The command includes a second instruction to configure the second set of properties with the corresponding values of the first set of properties according to the determined mapping. The configuration defines a first set of properties of the first controller and corresponding values of the properties.

In some embodiments, the first set of properties and the second set of properties include at least one of a data type, controller setpoint, object data structure, or control scheme.

In some embodiments, the processing circuit is configured to determine the second controller is compatible to be a clone of the first controller.

In some embodiments, the second set of properties is different than the first set of properties.

In some embodiments, the processing circuit is configured to communicate with the first controller and the second controller via a universal communication protocol.

In some embodiments, the configuration is further defined by an object model, and wherein properties in the first set of properties are associated with the object model.

In some embodiments, in order to determine the second set of properties the processing circuit is configured to generate an instance of the object model for the second controller.

In some embodiments, the received first instruction is based a user input indicating the identity of the first controller and the second controller.

In some embodiments, the first controller and the second controller are different controller models.

Various embodiments of the present disclosure also relate to a building management system (BMS) that includes a network interface configured to communicate with a first controller and a second controller in a building system. The BMS includes a processing circuit including a processor and a memory with instructions stored thereon that, when executed by the processor, cause the processor to receive a first instruction to copy a configuration of the first controller to the second controller, retrieve the configuration of the first controller, determine a mapping of the first set of properties to a second set of properties associated with the second controller, and send a command to the second controller. The configuration defines a first set of properties of the first controller and corresponding values of the properties. The command includes a second instruction to configure the second set of properties with the corresponding values of the first set of properties according to the determined mapping.

In some embodiments, the first set of properties and the second set of properties include at least one of a data type, controller setpoint, object data structure, or control scheme.

In some embodiments, the processing circuit is configured to determine the second controller is compatible to be a clone of the first controller.

In some embodiments, the second set of properties is different than the first set of properties.

In some embodiments, the network interface is based on a universal communication protocol.

In some embodiments, the first instruction is received from a user via a graphical user interface on a user device.

In some embodiments, the first controller and the second controller are produced by different vendors.

Various embodiments of the present disclosure relate to a method including receiving an instruction to clone configuration data of a first controller to a second controller. The method also includes retrieving the configuration data of the first controller; determining a mapping of the first set of properties to a second set of properties associated with the second controller, and sending a command to the second controller. The command includes an instruction to configure the second set of properties with the corresponding values of the first set of properties according to the determined mapping. The configuration data defines a first set of properties of the first controller and corresponding values of the properties

In some embodiments, the method further includes determining the second controller is compatible to be a clone of the first controller.

In some embodiments, the first set of properties and the second set of properties include at least one of a data type, controller setpoint, object data structure, or control scheme.

In some embodiments, the second set of properties is different than the first set of properties.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram illustrating a system manager, zone coordinator, and zone controller of the BMS of FIG. 2 in greater detail, according to some embodiments.

FIG. 4A is a block diagram of a device manager for facilitating cloning of a first device to other devices in a building system, according to some embodiments.

FIG. 4B is a block diagram of an enterprise management cloning system, according to some embodiments.

FIG. 5 is a block diagram of a controller configured in a BMS, according to some embodiments.

FIG. 6A is a flow diagram of a method for cloning the configuration of a source device to one or more destination devices, according to some embodiments.

FIG. 6B is another flow diagram of a method for cloning a device configuration via an enterprise manager, according to some embodiments.

FIG. 7 is a flowchart of a method for interfacing a user device to clone controller configurations in a building system, according to some embodiments.

FIGS. 8A and 8B are examples of a user interface that could be generated to facilitate cloning of controller configurations in a building system, according to some embodiments.

FIG. 9 is another user interface that could be generated to monitor cloning of controller configurations in a building system, according to some embodiments.

### DETAILED DESCRIPTION

### Overview

Referring generally to the FIGURES, methods and systems are disclosed herein with advantageous form, features, and configurations to improve building management systems. The methods and systems herein can be utilized to improve interoperability of devices in a building system, with notable advantage for building systems comprising devices designed by different vendors.

During installation of building equipment, a technician may be tasked with installing several of the same devices at a single site or multiple sites. Installation may include installing the physical device, uploading software onto a processing circuit associated with the device, and initializing settings to interface the device with other devices in the building system. Similarly, once the building equipment is online, a technician may want to uniformly update the configuration of a controller in each of the devices. Current systems may require the technician to set up each controller or device individually, which could involve the need to travel between the various sites in which the building equipment resides. Cloning methods may allow a technician to copy the configuration of one controller and apply the configuration to other controllers of similar function, type, and/or purpose. However, such cloning methods may still require a technician to set up each controller individual and/or may still require physically interacting with the controller on site, such as to upload a configuration file from a USB drive. There exists a need for a system to clone one or more controller configurations automatically without the need to be in physical proximity to the devices.

Another issue with cloning methods is that not all devices support built-in cloning functions. A cloning function may be a proprietary or device-specific process built-in to the firmware of a controller by the vendor to clone of the same model or vendor. Thus, for devices that do have supported cloning methods, devices from different vendors may not be able to interface together to clone configurations across vendors and/or models, limiting the ability to copy configurations across all relevant devices in the building system. A technician may only be able to clone devices of the same vendor with no means to copy configurations across vendors or models. There exists a need for a universal cloning method for any suitable controllers regardless of built-in cloning support or vendor.

The present disclosure provides solutions to these and other problems by implementing a cloud-based cloning system in a building management system, where a control configuration of a source device can be copied to one or more destination devices. The present disclosure allows a technician to configure multiple controllers of the same type quickly and from a single location, which may be via a user device local to one or more of the controllers, or a remote user device, such as an enterprise manager. The disclosed cloning process utilizes a universal communication protocol to define device configurations, and can apply said configurations to connected devices regardless of built-in functionality or vendor. Thus, technicians can save both time and hassle setting up controllers in a building system.

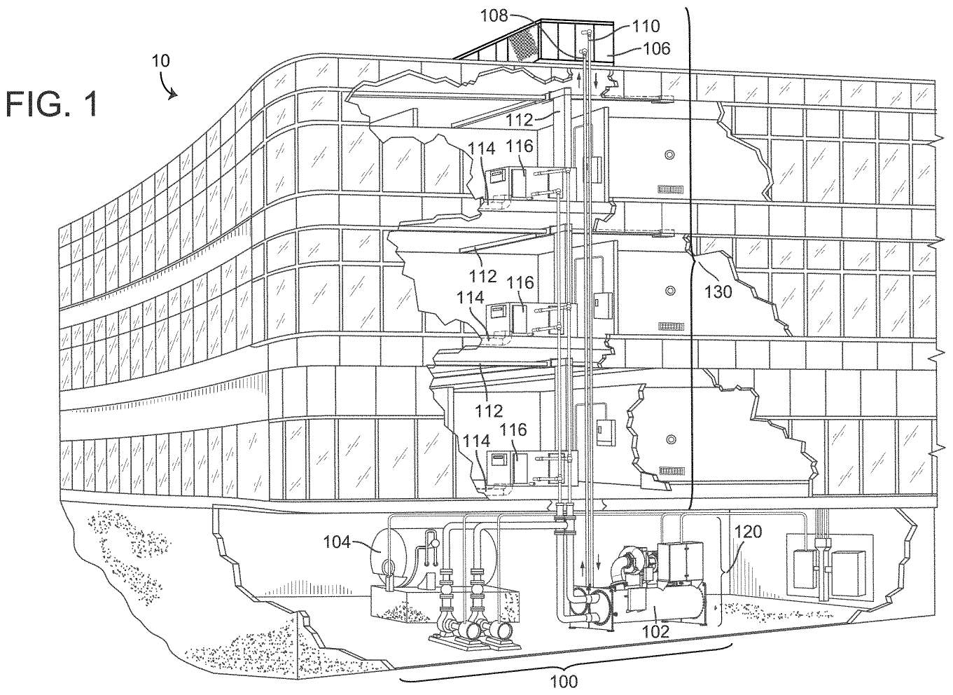

Referring generally to the FIGS. 1-3, a building management system (BMS) with automatic equipment discovery and equipment model distribution is shown, according to some embodiments. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

In brief overview, the BMS described herein provides a system architecture that facilitates automatic equipment discovery and equipment model distribution. Equipment discovery can occur on multiple levels of the BMS across multiple different communications busses (e.g., a system bus, zone buses, a sensor/actuator bus, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, the BMS can begin interacting with the new device (e.g., sending control signals, using data from the device) without user interaction.

Some devices in the BMS present themselves to the network using equipment models. An equipment model defines equipment object attributes, view definitions, schedules, trends, and the associated BACnet value objects (e.g., analog value, binary value, multistate value, etc.) that are used for integration with other systems. Some devices in the BMS store their own equipment models. Other devices in the BMS have equipment models stored externally (e.g., within other devices). For example, a zone coordinator can store the equipment model for a bypass damper. In some embodiments, the zone coordinator automatically creates the equipment model for the bypass damper and/or other devices on the zone bus. Other zone coordinators can also create equipment models for devices connected to their zone busses. The equipment model for a device can be created automatically based on the types of data points exposed by the device on the zone bus, device type, and/or other device attributes.

### Building and HVAC System

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

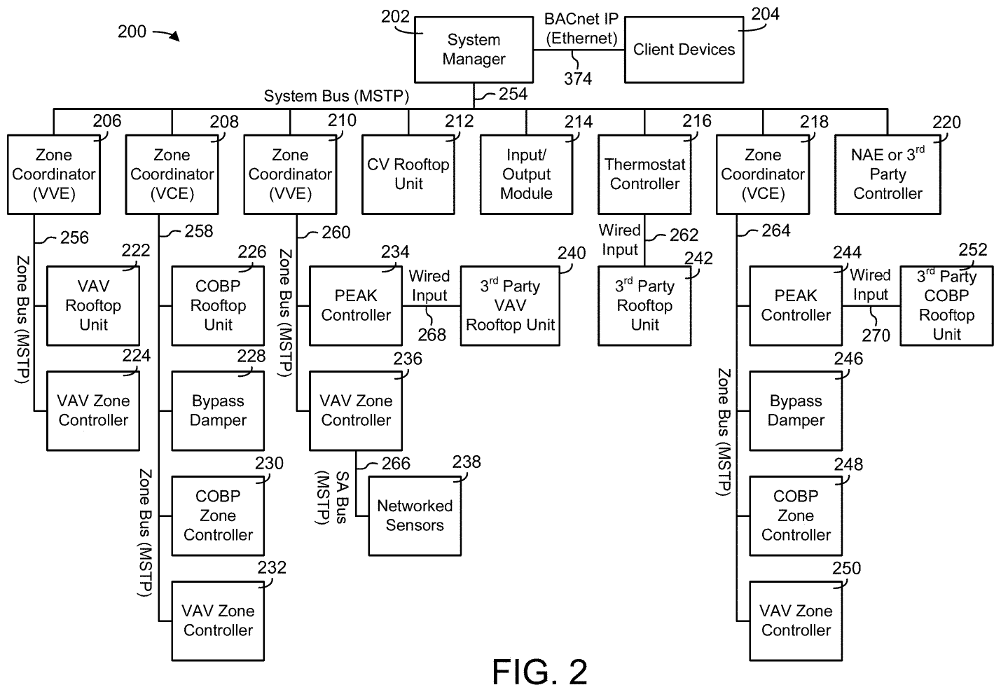

Referring now to FIG. 2, a block diagram of a building management system (BMS) 200 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 200 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications busses (e.g., a system bus 254, zone buses 256-260 and 264, sensor/actuator bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series or TEC3000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 244, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 244.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

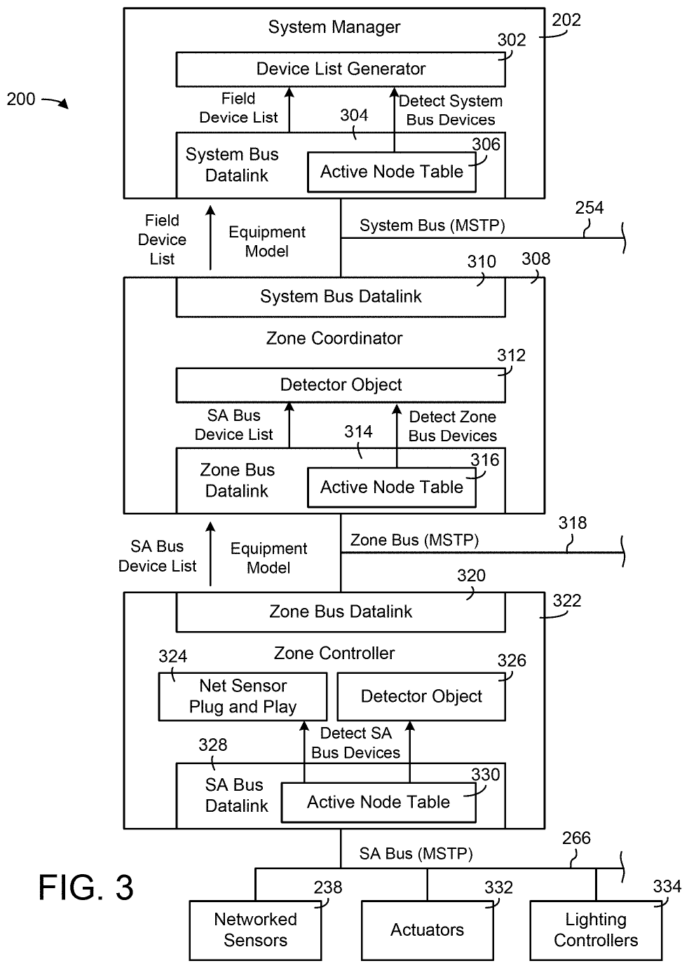

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communications bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device tree including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment model. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e. responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly-discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

### Vendor-Agnostic Attribute Cloning

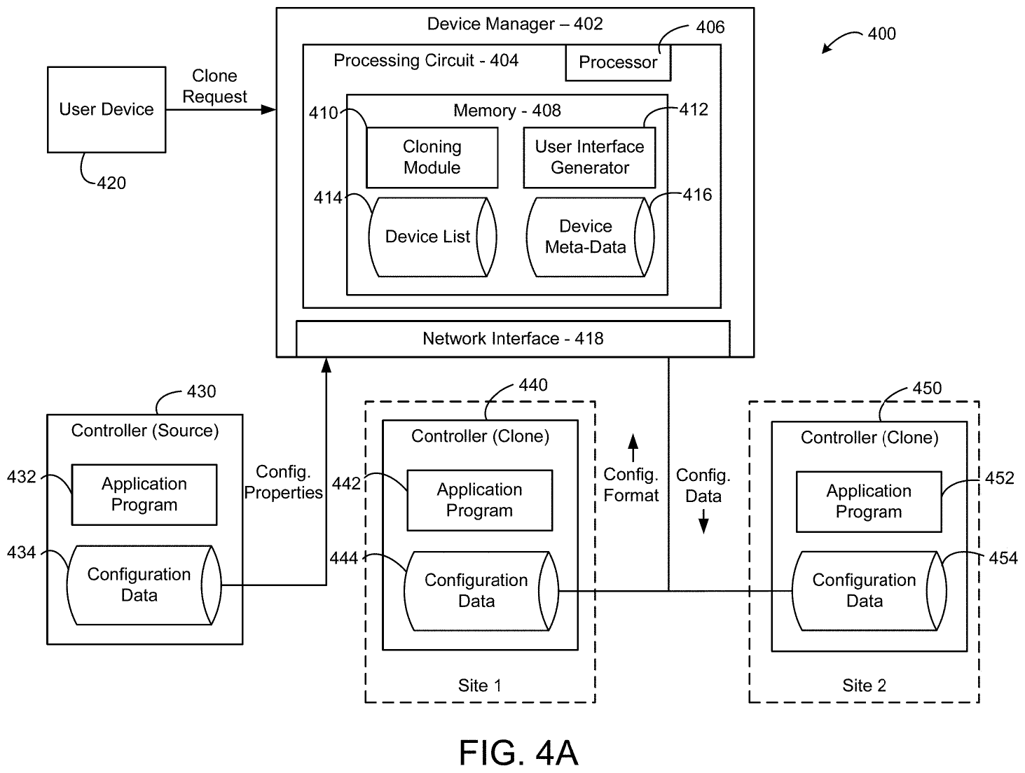

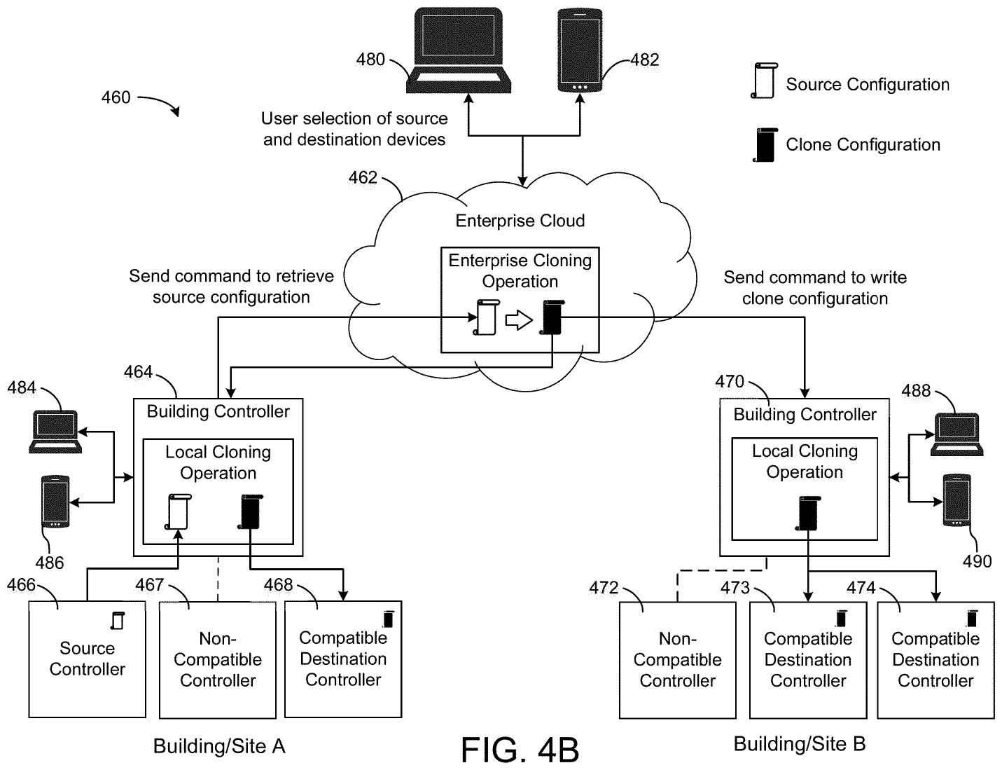

Referring now to FIG. 4A, a building system 400 for cloning device configurations is shown. Building system 400 includes a device manager 402, a user device 420, and two or more controllers, such as controller 430, controller 440, and controller 450. Building system 400 may be implemented as part of BMS 200, and may include any feature, configuration, or function as described in relation to BMS 200. Device manager 402 may generally be a supervising controller for the various devices in building system 400. Building system 400 may be operable for cloning of the configuration of the controller 430, designated as the source device, to controllers 440 and 450, designated as destination devices or clone devices.

Device manager 402 is shown to include a processing circuit 404 including a processor 406 and memory 408. Processing circuit 404 can be communicably connected to network interface 418 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components. In some embodiments, device manager 402 is implemented within a single computer (e.g., one server, one housing, etc.). In various other embodiments device manager 402 can be distributed across multiple servers or computers (e.g., that can exist in distributed locations).

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. The modules and subsystems shown in memory 408 may be implemented as hardware or software elements to execute one or more processes as described herein. According to some embodiments, memory 408 is communicably connected to processor 406 via processing circuit 404 and includes computer code for executing (e.g., by processing circuit 404 and/or processor 406) the one or more processes.

Memory 408 includes cloning module 410, which may enable device manager 402 to coordinate a cloning operation of a configuration of a source device to one or more destination devices. Cloning module 410 may be used to execute a series of data-retrieval and data-storing commands to extract relevant configuration parameters from the source device and configure the destination devices with corresponding parameters. Cloning module 410 may generally receive an indication of the source device and the one or more destination devices from another device in the building system 400, such as the user device 420, or may be configured to automatically clone configure a newly added device to the building system 400.

Cloning module 410 may use data stored in device list 414 to identify and communicate with the various controllers in the building system 400. Device list 414 may include any of a device name, address, device ID, device type, device purpose/function, or any other data pertinent to devices in the building system 400. Device list 414 may be automatically updated by device manager 402 as devices are added, removed, and reconfigured in the building system 400. In some embodiments, cloning module 410 may be configured to retrieve data from device list 414 to determine which devices are eligible for cloning or which devices are eligible for cloning from a particular source device.

Cloning module 410 may also be configured to retrieve device meta-data 416 to configure clone devices in the building system 400. Device meta-data 416 may include data related to the proprietary or application configuration of devices implemented in building system 400, which may be model-specific and/or vendor-specific. For example, device meta-data 416 may describe the data structures or objects to be configured on a particular vendor's product to enable the particular product to operate. In another example, device meta-data 416 may include mapping information for device models, such as naming conventions or sensor layouts. Cloning module 410 may use the device meta-data 416 to clone configurations of the source device to different models of destination devices or destination devices from different vendors.

Device manager 402 may also include an interface generator 412, which may facilitate the interfacing with a user to control the cloning process of one or more destination devices. Interface generator 412 may be configured to send and receive data between a user and device manager 402 such as cloning designations, cloning settings, and cloning progress. Interface generator 412 may be configured to generate a graphical user interface to be displayed to a user for receiving user input and outputting relevant information. Although shown as part of device manager 402, some embodiments of interface generator 412 may be implemented partially or entirely on user device 420.

Network interface 418 facilitates communication between the various devices of building system 400 and may implement a hierarchical structure wherein communication between devices may be relayed through layers of intermediate routers or controllers. Network interface 418 may define a standard communication protocol, such as BACnet, Modbus, or LonWorks, to package and direct service requests between devices in the network. Service requests may include read requests to query data from a device, write requests to instruct control on a device parameter, or custom service requests to perform a configured function.

User device 420 interfaces with the device manager 402 either directly, via the network interface 418, or another communication interface. User device 420 may be a mobile device, laptop, computer, tablet, or any other suitable device as discussed in relation to client device 204. The user may be able to send input parameters or cloning instructions to device manager 402 via the user device 420. The user device 420 may be configured to output a graphical user interface display to the user.

Controllers 430, 440, and 450 may be any controller or device a building, such as a TEC thermostat controller, zone controller, zone coordinator, PEAK controller, or any other controller. Accordingly, controllers 430, 440, and 450 may be designed to control and monitor a specific function, area, or type of device. In some embodiments, controllers 430, 440, and 450 are all the serve the same or similar function (e.g., a zone controller in a HVAC system). In some embodiments, the controllers 430, 440, and 450 are each from different vendors and may have different firmware, software, and configurations. In some embodiments, controllers 430, 440, and 450 are located at difference facilities or sites.

Controllers 430, 440, and 450 may each have application program 432, 442, and 452 and configuration data 434, 444, and 454. Application programs may be software or firmware stored on the controller to facilitate operation of the controller. In some embodiments, the application programs define generic function, and an application specific implementation (e.g., installation in a particular building system or a particular function) is defined by the configuration data. In some such embodiments, the application program may configured to read the configuration data to implement the application specific function. Application programs may also include network functions, such as processes to automatically connect to the network interface 418 or otherwise make known the controller's presence in the network. Application program 432, 442, and 452 may be pre-installed by the vendor at the time of production or uploaded by a technician during installation.

The configuration data 434, 444, and 454 generally define properties of their respective controller that indicate how the controller should operate. The configuration data may include software or firmware related to the application program 432, 442, and 452 or mappings of connected devices to controllers 430, 440, and 450. In some embodiments, the mappings may correlate a connected device to a particular property or object model. The configuration data may also include configuration data for communicating and interfacing with other devices via the network interface 418. A configuration may generally be defined by either a template or listing of properties, and values corresponding to the properties. Accordingly, systems with different configurations may indicate the systems have different listings of properties and/or have different values for corresponding properties.

In some embodiments, configuration data 434, 444, and 454 contain configuration data corresponding to devices associated with controller 430, 440, and 450, respectively. For example, controller 430 may comprise configuration data for a subcontroller supervised by controller 430. Accordingly, the configuration data for associated devices may have any of the same structures and features, where the supervising controller can relay or process service requests related to the associated devices.

Controller 430 may be designated as the source controller for a cloning process. Device manager 402 may be configured to retrieve a listing of properties or configuration template from controller 430 for processing in the cloning sequence. Device manager 402 may also be able to retrieve the values corresponding to the controller properties. Device manager 402 may utilize meta-data corresponding to the controller 430 to determine which parameters to copy to the clone devices. For example, properties of controller 430 may be indicated as inherent to only controller 430, such as a unique part number or a unique device ID, and accordingly unsuitable to clone to another device. In some embodiments, the parameters are retrieved from controller 430 according to a generic template of properties stored in the device meta-data 416.

Controllers 440 and 450 may be designated as the destination device for cloning. As would be appreciated by one of ordinary skill in the art, cloning may be performed with only one of controllers 440 and 450, or more than controllers 440 and 450. Device manager 402 may be configured to retrieve a configuration format related to both controller 440 and controller 450 individually. Data regarding the configuration format of a particular controller may also be retrieved from device meta-data 416. In some embodiments, the device manager 402 is configured to retrieve values corresponding to properties in the configuration data prior to cloning the controllers 440 and 450. Cloning controllers 440 and 450 may include sending configuration data or property values to the controllers 440 and 450 to overwrite or augment configuration data 444 and 454, respectively. Controllers 440 and 450 may be cloned sequentially or in parallel.

Referring now to FIG. 4B, an enterprise management system 460 is shown. Enterprise management system 460 may be a configuration of building system 400, and can include any feature or component discussed therein. Enterprise management system 460 defines tiers of control between an enterprise cloud 460, building controllers 464 and 470 local to a building or site, and various equipment controllers associated with the building controllers 464 and 470. Enterprise management system 460 generally clones a configuration of a source controller to one or more destination devices across different buildings in the enterprise. Although two building controllers are shown, it should be appreciated that more building controllers may be managed by the enterprise could 462, and similarly, more equipment controllers and devices than those shown.

Enterprise cloud 462 contains servers and/or other computing devices to enable communication with building controllers 464 and 470 in the enterprise management system 460. Enterprise cloud 462 may utilize a standardized communication protocol, such as but not limited to BACnet or LonWorks, to facilitate communication between devices. Enterprise cloud 462 is also configured to facilitate and/or execute an enterprise-level cloning operation between equipment controllers in the enterprise. The enterprise-level cloning operation may comprise communicating with the building controllers 464 and 470 to send and receive configuration data for equipment controllers controlled by the building controllers 464 and 470, and may include sending commands to perform local cloning operations on building controller 464 and 470.

Building controllers 464 and 470 may generally manage and control devices in the respective building sites. Building controllers 464 and 470 may have local cloning operations that facilitate cloning of the devices local to the building site. The local cloning operations may include specific configuration data for the devices associated with the building controllers 464 and 470. In some embodiments, building controllers 464 and 470 comprise built-in cloning routines associated with a particular model or vendor of equipment controllers than can be used to expedite the cloning operation.

Source controller 466 is managed by building controller 464. Destination controllers 468, 473, and 474 can be designated across the enterprise management system 460 and controlled by different building controllers. Equipment controllers may be characterized by whether they are compatible for cloning with the designated source controller. For example, non-compatible controller 467 and 472 may be excluded from a cloning operation based on the controllers 467 and 472 being incompatible with the source controller configuration. Compatibility may be based on a controller type, function, configuration, or implementation. Compatibility may be determined by building controllers 464 and 470 or by the enterprise cloud 462.

An enterprise manager can access and interface with the enterprise cloud 462 via an enterprise user device 480 or an enterprise mobile device 482. Enterprise user device 480 may be a laptop, desktop computer, or other computing station accessible by the enterprise manager. Enterprise mobile device 482 may be a mobile user device capable of accessing data in the enterprise cloud 462, such as a mobile phone or tablet, for example. Enterprise user device 480 and enterprise mobile device 482 may be configured to display a graphical user interface to the enterprise manager to receive user input and display relevant data to a cloning operation in the enterprise management system 460.

Local user devices 484 and 488, as well as local mobile device 486 and 490, provide access to local managers local to the building controller 464 and 470, respectively, to the building control systems. Local user devices 484 and 488 may be dedicated laptops, desktop computers, or other computing stations accessible at the respective building or site. Local mobile device 486 and 490 may be user mobile devices, such as a smartphone, tablet, or other mobile computing device. Local user devices 484 and 488 and local mobile device 486 and 490 may enable the local managers to input control data and view data corresponding to controllers at the respective building site, and may be configured to generate a graphical user interface to facilitate input and output to the local managers.

In enterprise management system 460, the enterprise manager can designate a source controller and one or more destination controllers for a cloning operation from devices in the enterprise management system 460. The enterprise cloud 462 may then identify the building controller associated with the source device, and send a command to the building controller 464 to retrieve configuration data of the source controller 466. The building controller 464 may be configured to utilize local cloning operations to retrieve and package configuration data to be sent to enterprise cloud 462. Enterprise cloud 462, or in some embodiments, building controller 464 and 470, convert the source configuration into a clone configuration to be distributed to the one or more destination controllers. The enterprise cloud 462 may then identify the appropriate building controllers and send the clone configuration data to the appropriate building controllers with a command to configure the destination controllers with the local cloning operations. In this way, computation and processing power required to execute the cloning operation can be distributed across several controllers rather than consuming processing resources of the enterprise cloud 462.

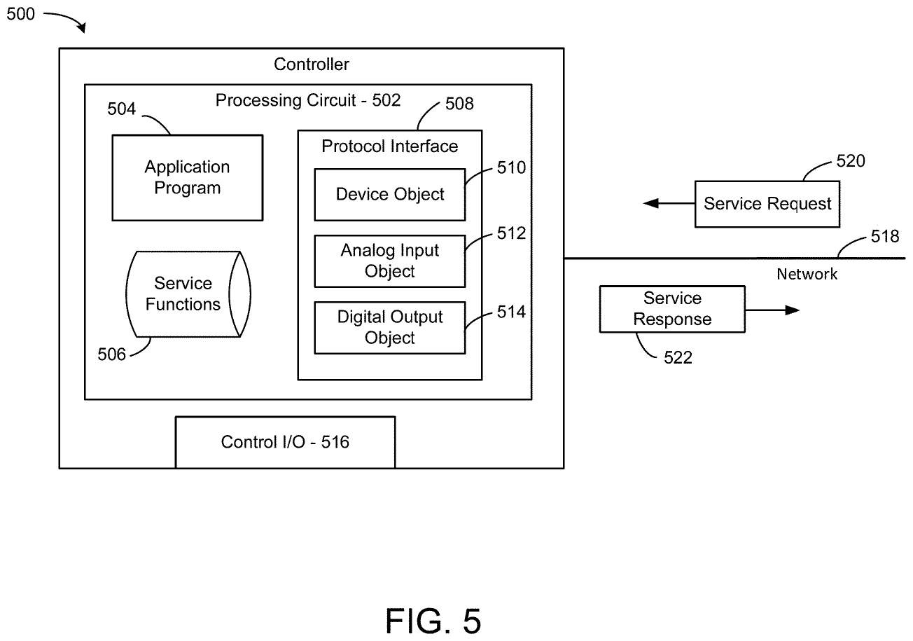

Referring now to FIG. 5, a block diagram for a device controller 500 is shown, according to some embodiments. Device controller 500 may be a controller in BMS 200 or building system 400 configured to interface with other devices and controllers over network 518. Device controller 500 may be configured to monitor and control a particular building equipment, another controller, a particular zone or building, or any other subsystem. Device controller 500 may be configured to communicate with the other devices via a universal communication protocol, such as BACnet, Modbus, or LonWorks.

Controller 500 is shown to include a processing circuit 502 with application program 504, service functions 506, and protocol interface 508. Processing circuit 502 may be configured in some embodiments with a processor and memory, wherein software instructions stored in the memory are executable by the processor to perform various processes. Processing circuit 502 may be implemented as a FPGA, microcontroller, ASIC, or any other suitable electronic components, and combinations thereof. Controller 500 may be, for example, TEC thermostat, zone coordinator, zone controller, PEAK controller, or any other controller.

Controller 500 is connected to network 518 via one or more communication interfaces. Network 518 may define a standard communication protocol for communication between devices in a building network. The communication protocol may generally define a service request template 520 and a service response template 522. The service request template 520 may define a target device and a service command, such as a read or write command. The controller 500 may be configured to recognize and respond to service requests 520 received from network 518. Controller 500 may then respond to service requests 520 with service response 522, which may indicate a success or error of the service request or provide requested data to the sender of the service request. The service response 522 may be addressed to the sender of the service request.

Control I/O 516 is an interface to sensors, actuators, and other devices controlled by controller 500. Controller 500 may generally manage and monitor devices on control I/O 516, such as measuring received input or outputting control parameters. Controller 500 may also be configured to relay communication packets to devices connected to control I/O 516. In some embodiments, controller 500 is an agent for the connected devices to the network 518, wherein the controller 500 processes packages and manages configuration properties of the associated devices in relation to the protocol interface 508.

Application program 504 may be understood to be software and programs loaded onto the controller 500 for executing general or specific functionality of the controller 500. For example, application program 504 may include firmware and base libraries for executing functionality on the controller 500. In some embodiments, application program 504 may be pre-installed on the controller 500 by the vendor of controller 500 during or after production of the controller 500. In some embodiments, application program 504 is downloaded or otherwise installed onto controller 500 by a technician installing the controller 500. Application program 504 may include software and configurations to automatically connect to the network 518 or otherwise broadcast its identity and presence to other devices on the network 518.

Protocol interface 508 may be defined for a network to facilitate communication and interoperability between devices of different models and vendors. Protocol interface 508 may define template objects associated with the controller 500 that are standardized across similar device types in the network 518. Objects may be define as a data structure with a variety of properties (used interchangeably with attributes) attributes associated with the object. Each property may have an associated value. Objects and parameters in the protocol interface 508 may be updated and maintained by controller 500 via the application program 504 or service functions 506. In such embodiments, objects and properties in the protocol interface 508 provide an intermediary layer between application programs 504 and other devices in the network 518.

Properties in protocol interface 508 may be static or dynamic, where a static property is one intrinsic of the controller 500 (e.g., vendor, model number, etc.), and a dynamic property is a property able to be set or changed (e.g., device name, control setpoint, sensor value, etc.). Properties may also have associated permissions, where a locked or blacklisted property may be unchangeable from control or change by another device. In some embodiments, blacklisted properties may be temporarily unlocked during a configuration mode before being restricted again in an online mode.

Protocol interface 508 may define one or more objects, such as a device object 510, analog input object 512, and digital output object 514. Device object 510 comprises general or identifying properties of the controller 500, such as a name, device ID, model, vendor, device type, location, or address, such as a fully qualified reference (FQR), for example. Device object 510 may also contain information regarding other objects defined by controller 500. Controller 500 may come pre-configured with the device object 510 to facilitate automatic identification of the controller 500 on network 518. Analog input object 512 may generally define an input device connected to controller 500 via control I/O 516. Analog input object 512 may define properties of the input device, such as name, type, output range, model, vendor, measured value, update rate, and other properties. In some embodiments, the analog input object 512 may define a property for a hardware port or interface the input device is connected to. The digital output object 514 may be representative of a control parameter of the controller 500, and may include properties such as a name, model, vendor, setpoint range, and setpoint value for the control parameter. The control parameter may relate to a device connected via the control I/O 516. The digital output object may allow another device in network 518 to write a value to the setpoint value in the digital output object 514 to change control of the associated device.

Other features, objects, and property configurations may be appreciated for inclusion into protocol interface 508. For example, objects and properties may be defined for alarm events and conditions, timers, file transfer, event handlers, schedules, loops, calendars, other inputs and output configurations (such as multi-state inputs and outputs), and other relevant features. In some embodiments, Objects and properties may also be defined to list defined objects or available service functions. In some embodiments, properties and function calls are defined outside the context of any particular object structuring in addition or alternative to the data structures discussed herein.

Service functions 506 can include internal processes execution of controller 500 and external service calls available to other devices on network 418. Service functions 506 may be defined as part of a device configuration for a particular purpose or implementation of controller 500. Protocol interface 508 may also define function calls related to a particular object or properties. For example, protocol interface 508 may define a function call to read a particular property of a particular object by another device in the network 518. As another example, protocol 508 may define a function call to write to a particular control value of a property in protocol interface 508. Service functions may also be stored to read and write entire files on controller 500, such as uploading and updating firmware or software. As should be appreciated, part or all of service functions 506 may be implemented as part of the protocol interface 508 in some embodiments.

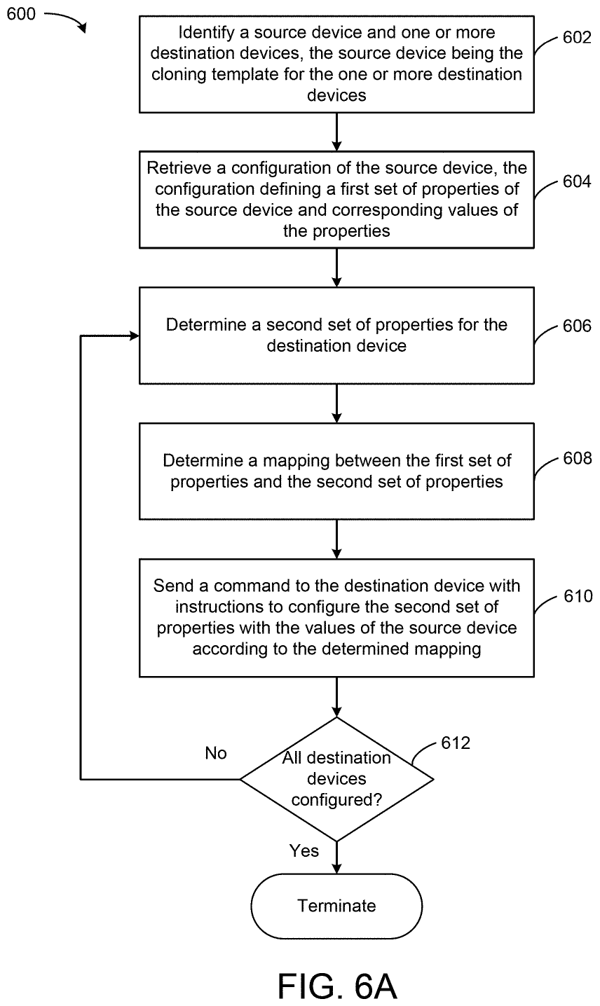

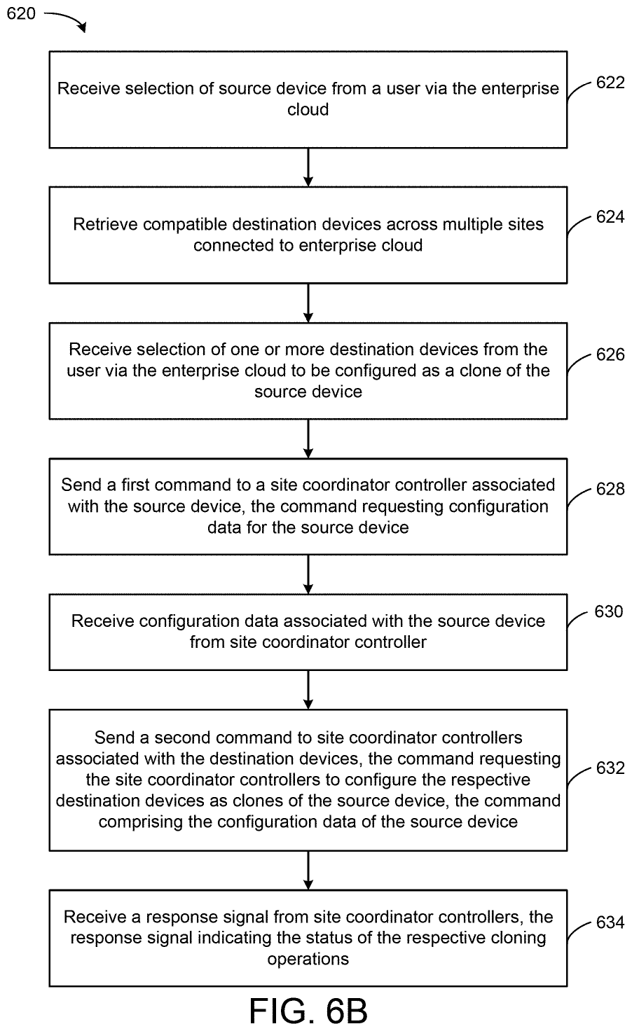

Referring now to FIG. 6A, a flow diagram of a cloning method 400 is shown, according to one embodiment. Method 600 may be executed by system manager 202, zone coordinator 308, or device manager 402, for example. Method 600 generally copies the configuration settings of a source device to one or more destination devices. In some embodiments, the source device and destination devices are controllers in the building system, such as TEC thermostat, zone coordinator, zone controller, PEAK controller, or any other controller, and may be different models or produced by different vendors. A system executing method 600 may generally rely on a standardized communication protocol to request, receive, and write information on connected devices, and may utilize one or more layers of intermediate controllers to facilitate communicate between the various devices in the building network.

At 602, the source device and one or more destination devices are identified, where the source device is designated as the template from which the one or more destination devices are being cloned. The identification of the source device and the destination devices may be based on an indication received from another device or memory. Operation 602 may include identifying the source device and destination devices by a unique device identifier, such as a FQR or device address. A system implementing operation 602 may be configured to determine, based on the source device, a list of potential destination devices capable of being copied as a clone of the source device. In some embodiments, the system may be configured to automatically queue each suitable destination device for cloning.

In some embodiments, a user input is received, and the source device and destination devices are identified based on the user input. The user may select the source device and the destination devices from a list of connected devices in a building system and transmit the selection to the system implementing operation 602. In some embodiments, the list of connected devices may be filtered based on devices that are the same type as a selected source device. In some embodiments, the user may first select a destination device to be configured, and the user selects a source device for cloning from a list of eligible devices.

At 604, a configuration of the source device is retrieved. The configuration may be retrieved from the source device or a managing device that serves as an agent for the source device in the building network. The configuration generally defines properties and attributes indicative of how the controller operates and interfaces with other devices in the building system. A configuration may also include data structures, objects, function calls, firmware, software, or other relevant configuration data. Configurations of different devices may be different depending on the device model or vendor. The set of properties defined by the configuration of the source device may be designated as a first set of properties, where the first set of properties have associated values corresponding to each of the properties.

In some embodiments, the properties retrieved for the source device may be pruned to reduce properties not suitable for cloning to other device. For example, a unique device ID may not be suitable to copy to other, similar devices, whereas a designated device type may be suitable to copy to other devices. In some embodiments, the properties in the first set of properties may be classified as dynamic or static properties.

At 606, a destination device is selected from the one or more destination devices, and a second set of properties is determined for the destination device. The second set of properties may be different than the first set of properties for the source device. The second set of properties may be based on vendor-specific implementation, purpose, or configuration of the destination device. The second set of properties may generally outline a template of control parameters that can be configured using data from the source device configuration.

The second set of properties may have values associated with some of the properties in the second set. Some values may be dynamic, while others static and blacklisted. Accordingly, not all properties in the second set of properties may be eligible for cloning of data in the source device configuration. In some embodiments, meta-data for the destination device may be retrieved from the destination device, such as pre-configured software, a controller supervising the destination device, or device-specific data available in a database. Meta-data may include a device type, device name, device ID, associated sensors and actuators, and other relevant data specific to a particular destination device.

In some embodiments, using meta-data of the destination device, it may be determined at 606 that additional object models may need to be generated for the destination device before copying property values from the source device to the destination device. The creation of object models may be initiated by the system sending a command to the destination device to create the object model data structure and associated properties.

At 608, a mapping between the first set of properties and the second set of properties is determined. The mapping may be used when the source device and the destination device do not have the same object models or the same attributes. In some embodiments, the mapping may be used to associate the configuration of a particular sensor in the source device with the corresponding sensor in the destination device. In some embodiments, responsive to a determination that the source device and the destination device are the same make and model, a one-to-one mapping may be implemented for each eligible property to streamline cloning.

At 610, a command is sent to the destination device with instructions to configure the second set of parameters with the values of the source device according to the determined mapping. In some embodiments, the properties in the second set of properties are iteratively configured, such that a command is sent for each property of the first set of properties corresponding to a property of the destination device. In some embodiments, the command is batch command of the multiple properties to be configured and the corresponding values. The command may rely on service request calls defined by the universal communication protocol, which may designate the format and content of the command.

At 612, a determination is made whether each designated destination device has been configured. Responsive to the determination that there remains another destination device to configure, the method 600 repeats at 606 with the new destination device. As would be appreciated by one of ordinary skill in the art, each of the destination devices may have a different set of properties to be configured and thus would be preferred to be configured separately. Responsive to the determination at 612 that all designated destination devices have been configured, the process may then terminate.

In some embodiments, where each of the destination devices share the same configuration (e.g., have a common second set of properties), method 600 may be executed where property values are sent to each destination device together prior to configuring the next property value. Such embodiments may be implemented using a broadcast command to the relevant devices.

Referring to FIG. 6B, another method 620 for cloning building devices via an enterprise management system. Method 620 may be executed by servers in enterprise cloud 462, for example. Method 620 generally enables a server to facilitate cloning of a source device to one or more destination devices across the enterprise management system. A server executing method 620 may be configured to receive input from a user at the enterprise level rather than a user local to a building or site.

At 622, a designation of a source device for cloning is received from a user device connected to the enterprise cloud. The source device may be identified by a device identifier or device ID. The source device may also be designated by a building controller by which the source device is controlled or managed. The source device may be associated with a vendor or model of the source device.

At 624, a list of compatible devices across the enterprise management system compatible to be a clone of the identified source device is retrieved. In some embodiments, a query request is sent to one or more controllers in the enterprise management system with identifying information or meta-data of the source controller. In some embodiments, the list may be retrieved from a database storing information about controllers in the enterprise management system. The retrieved list of compatible devices may be presented to the user via a user interface.

At 626, a selection of one or more destination devices in the list of compatible devices may be received from the user. In some embodiments, the selection indicates the location or building site of the destination devices. In some embodiments, the selection is an indication that all controllers of a particular type, model, or location should be configured as a clone. For example, the selection may indicate that all compatible controllers are to be configured as a clone of the source device, or in another example, all compatible controllers at a particular site.

At 628, a first command is sent to a site coordinator controller associated with the source device requesting configuration data of the source device. In some embodiments, the site coordinator controller is the building controller 464 or 470 that manages the source device. In some embodiments, the server is configured to determine which site coordinator controller is associated with the source device. In some embodiments, the first command indicates a specific type of configuration data to retrieve.

At 630, configuration data associated with the source device is received from the site coordinator controller. In some embodiments, the configuration data comprises a configuration template used by the source device. In some embodiments, the configuration data comprises a listing of properties of the source device and associated values of the properties. In some embodiments, the configuration data is stored for subsequent use and manipulation. In some embodiments, the method 620 includes the step of converting the source configuration to one or more clone configurations. The clone configurations and the source configurations may be in different formats, orders, or data structures based on the type of controller or vendor. The clone configuration may also remove configuration properties of the source configuration not suitable for cloning to other controllers.

At 632, a second command is sent to various site coordinators in the enterprise management system associated with the designated destination devices. In some embodiments, the appropriate site coordinator controllers are identified based on which controller manages a device of the designated destination devices. The command generally requests the site coordinator controllers to configure the appropriate destination devices according to the source device. The command may also include configuration data from the source device, which may be the clone configuration. In some embodiments, the source configuration is sent to the site coordinator controllers, and the site coordinator controllers configured the clone configurations. The second command may be broadcasted to the site coordinator controllers, or may iteratively send the command to each site coordinator controller.

At 634, a response signal is received from the site coordinator controllers indicating the status of the respective cloning operations. The status of the cloning operation may be, for example, paused, in-progress, complete, or failed. The server may be configured to respond appropriately to the status of the cloning operations. In some embodiments, the respective statuses are sent to the user for review.

### User Interface for Device Cloning

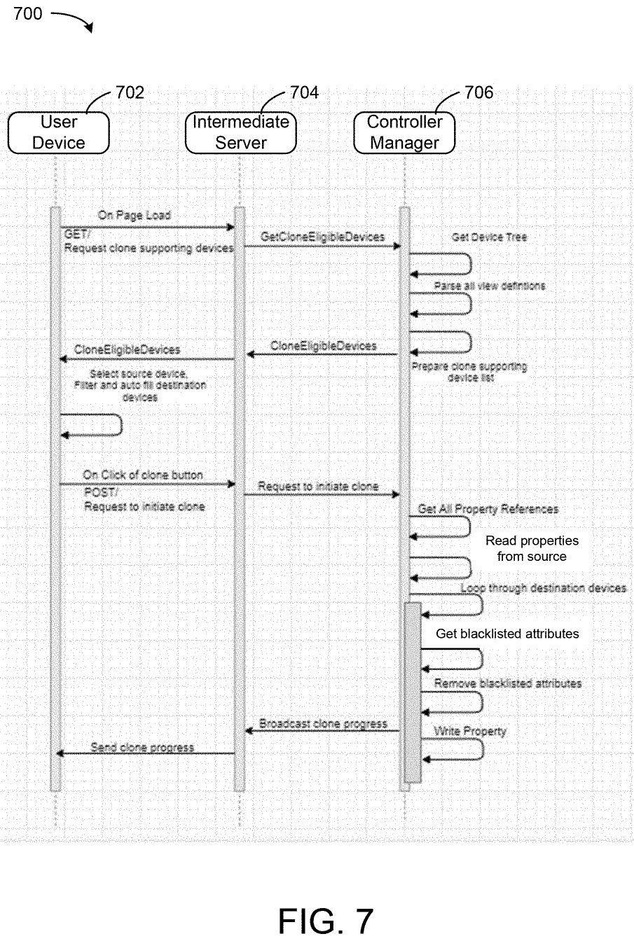

Referring now to FIG. 7, a system flowchart is shown for device cloning in a distributed system 700. The distributed system 700 may include a user device 702, controller manager 706, and an intermediate server 704. The distributed system 700 may implement the depicted operations to execute a user-initiated cloning method using one or more generated user interfaces on the user device 702.

User device 702 may be any of client device 204 or user device 420, for example. The user device 702 may be configured for receiving user input and outputting data related to cloning algorithms. The user device 702 may be configured to generate and present a graphical user interface in which the user can monitor and control cloning operations in the building system. The user interface may output lists of eligible devices for cloning and receive a user input designating a source device and one or more destination devices.

Intermediate server 704 may facilitate communication between the user device 204 and the controller manager 706. Intermediate server 704 may include authentication interfaces for increased security and protection of the controller manager 706 from unauthorized users. Intermediate server 704 may generally manage multiple user devices attempting to access controller manager 706 and facilitate appropriate data routing, which may include providing application programming interfaces, servicing functions, and data packing. Although not explicitly stated in the following description of distributed system 700, it should be appreciated that each of the communications between the user device 702 and controller manager 706 can be interfaced through the intermediate server 704.

Controller manager 706 may be system manager 202 or device manager 402, for example. Controller manager 706 generally executes or coordinates the capabilities described to execute controller cloning in the building system.

As depicted, the distributed system 700 may implement control of device cloning by first requesting by the user device 702 clone supporting devices in the building system. Controller manager 706 may then get an associated device tree, parse the available devices, and prepare a listing of clone-eligible devices to send to the user device 702. The user device 702 may then select a source device from the receive list. In some embodiments, the source device is selected via a graphical user interface, and the remaining devices are filtered based on which devices are capable of being cloned to be copies of the source device. The filtering may be performed based on a device type of the source device. The user may then initiate the cloning processing via the user interface. The request may include the designation of the source device and the one or more destination devices.

The cloning process executed by the controller manager 706 may be similar to or contain any operation or feature of method 600. The controller manager 706 may retrieve the property references of the source device. The retrieval of the property references may be performed by executing a service request of the source device of a list of all defined properties or objects of the source device. The controller manager 706 may then subsequently send a read request for the retrieved property references from the source device and store the values in local memory.

Then, for each destination device, the properties of the destination device may be collected via a service request sent to the destination device. The controller manager 706 may also request property definitions or permissions to determine which attributes are blacklisted and thus unable to be configured to set by controller manager 706. The blacklisted attributes may then be removed, and the remaining properties may be configured with the appropriate values retrieved from the source device. This process can be repeated for each of the destination devices until each destination device has been configured.

During the property writing process, progress metrics may be communicated to the user device 702 to allow the user to monitor progress of the cloning process. Progress metrics may be transmitted as a percentage of the number of properties written on a destination device versus the total number of properties to be written to the destination device. In some embodiments, the progress metric is measured as a percentage of the number of properties written to a destination device versus the total number of properties defined for the destination device. Progress metrics may also convey how many of the destination devices have been configured.

In some embodiments, where a property is designated as required but lacks a corresponding value in the source device to copy, the controller manager 706 may send a missing data request to the user device 702 responsive to a determination the required attribute is required, and the user may be prompted on user device 702 to input the missing value for the required attribute. The user device 702 may then send the value to the controller manager 706 to write the corresponding property on the destination device. The input may be used to configure the other destination devices where applicable. It should also be appreciated that the same operations can be used for optional properties not otherwise represented by the source device. Such embodiments thus provide a more complete configuration of the destination devices from a remote location with streamlined cloning the majority of the properties.

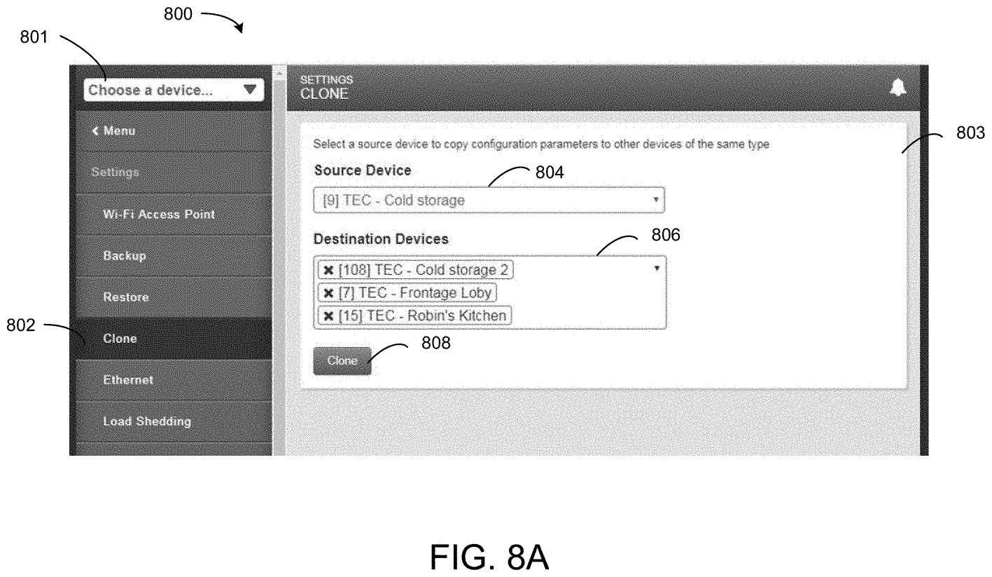

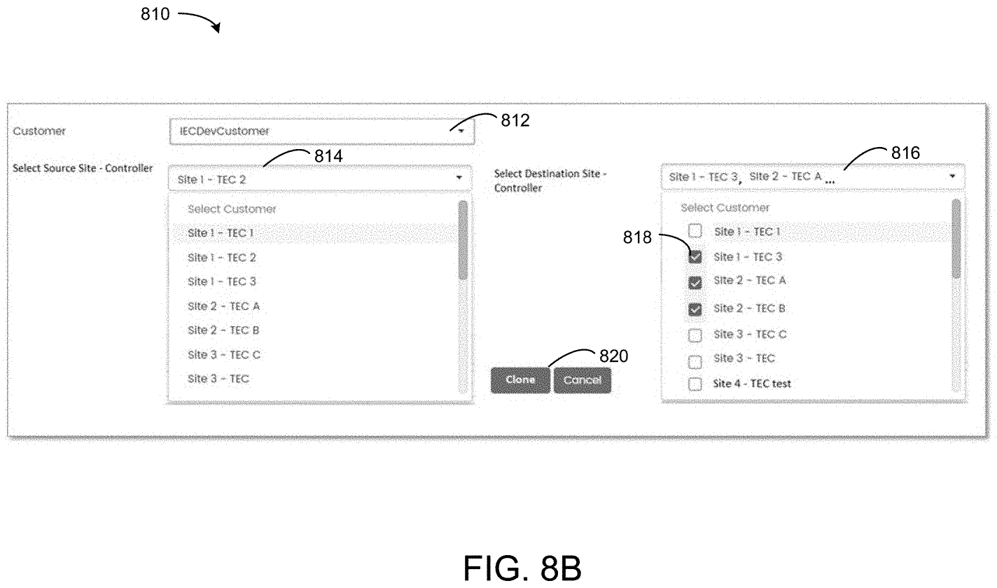

Referring now to FIG. 8A, a graphical user interface 800 is depicted for cloning controllers in a building system. The user interface 800 may be generated and presented to a user via a user device, such as user device 420 or user device 702, for example. User interface 800 may be incorporated into a local-system interface or enterprise management interface for managing various devices, alerts, and control of devices in a building system.

User interface 800 may include a navigation bar 801. The navigation bar 801 may be used to search for particular controllers or devices in the managed building system. For example, a user may be able to search for a device may name, device ID, device type, or device location. The navigation bar 801 may be used to retrieve additional information about the particular device. In some embodiments, a device can be searched to initiate a device cloning sequence.

User interface 800 may include a navigation tree 802. Navigation tree 802 may generally outline various functionalities or menus available in the management interface in a hierarchy. For example, for a given feature, such as settings, additionally subfunction or sub-features can be selected by a user. In some embodiments, the management interface has a specific node for cloning devices in the building system. User interface 800 may be generated and/or displayed responsive to a user selection of the cloning node in the navigation tree 802. In some embodiments, navigation tree 802 is configured as a hierarchy of devices in the building system, where the user can select a device from the tree to be presented additional data related to the selected device.

With continued reference to FIG. 8A, user interface 800 may also include a user input widget 804 to designate a source device to clone. Widget 804 may be displayed in a cloning window 803. Widget 804 may be configured as a text input, wherein the user can search for the device name or device ID of a device to designate as the source device. In some embodiments, widget 804 is a drop-down list, such that the user can select the source device from a list of eligible devices. Other input means can be appreciated as widget 804 to allow a user to select the source device.

The user interface 800 may also include another user input widget 806 to designate the destination devices to be configured as clones of the chosen source device. Widget 806 may also be displayed in the cloning window 803. In some embodiments, widget 806 may be configured as a text input, wherein the user can search for the device name or device ID of a device to designate as the destination device. In some embodiments, widget 806 is a drop-down list, such that the user can select the destination device or devices from a list of eligible devices. Destination devices may be filtered and displayed based on which devices are eligible to be a clone of the designated source device. Ineligible devices may be removed from a listing of options made available to the user, or may in addition or alternative be graphically displayed to designate the incompatibility with the source device, such as a strikethrough, change in font style, or error symbol displayed in association with the ineligible source devices. Other input implementations that enable the user to select one or more destination devices can be appreciated as widget 806.

User interface 800 can also include button 808 to initiate a device cloning sequence. The device cloning sequence may be initiated responsive to the user selecting the button 808. The interface may be configured to transmit the selected source device and destination devices to a system executing the device cloning.

In alternate embodiments, rather than selecting destination devices eligible for a particular source device, user interface 800 may be configured to filter and display eligible source devices for a given destination device. Accordingly, a user may be able to select a particular device to configure, such as via navigation bar 801 or navigation tree 802, and select a source device to copy from a list of potential source devices. Selection of button 808 by the user may then similarly initiate the cloning sequence using the selected destination device and source device.

Referring to FIG. 8B, another user interface 810 that can be presented to a user is shown. In some embodiments, user interface 810 is used alternatively to window 803 in user interface 800. User interface 810 may be suited for interfacing via an enterprise management device, such as enterprise user device 480 or enterprise mobile device 482. User interface 810 can include any feature or component as described in relation to user interface 800.

User interface 810 includes widget 814 for selecting the source device of a cloning operation and a widget 814 for selecting one or more destination devices. Widget 814 and widget 816 may be configured as drop-down lists, such that the user can select the source device and destination devices from a list of eligible devices. Devices may be filtered and displayed based on which devices are eligible to be a cloned. Ineligible devices may be removed from a listing of options made available to the user, or may in addition or alternative be graphically displayed to designate the incompatibility with the source device, such as a strikethrough, change in font style, or error symbol displayed in association with the ineligible source devices. Widget 814 and 816 may designate the site or location of each clonable device in addition to the name or ID of the device. Widget 816 is shown to include checkboxes 818 in the dropdown list that may be used to select and deselect the one or more destination devices.

User interface 810 includes filter 812, which may be used to narrow the selectable devices in the widget 814 and/or 816. Filter 812 may be configured as a text entry or drop down list to filter the displayed devices. For example, filter 812 may allow a user to specify a type of controller for cloning, such as TEC thermostat controllers or HVAC controllers. Responsive to a selection of filter 812, the widgets 814 and 816 may be updated to only show devices registered as TEC thermostats. As another example, the filter 812 may enable a user to select a specific vendor of controller or model of controller to filter the available source and destination devices. Other criteria of filter 812 may be appreciated as discussed herein.

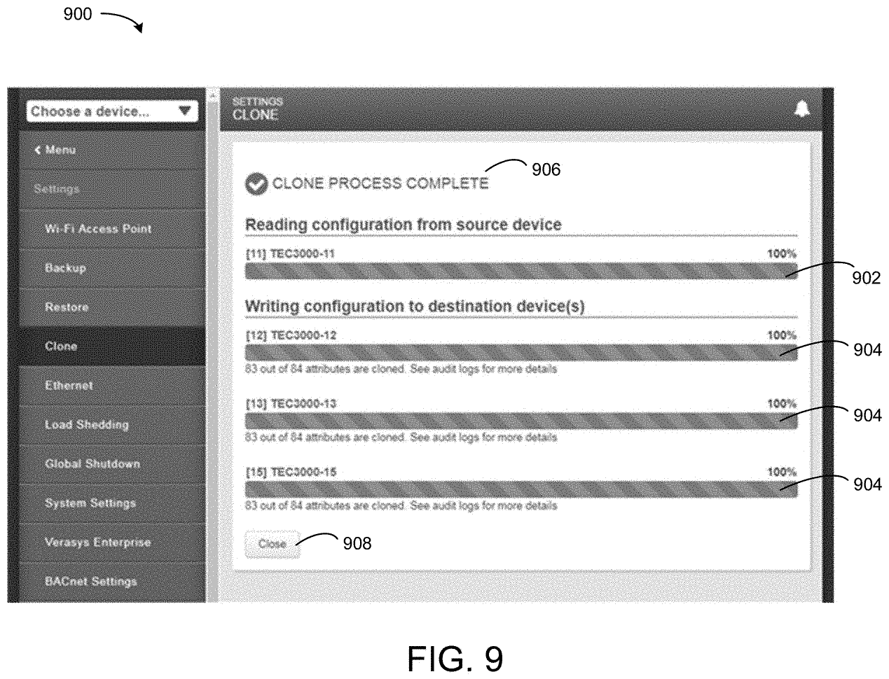

Referring to FIG. 9, another user interface 900 is depicted for monitoring device cloning in a building system. The user interface 900 may be generated and presented to a user via a user device, such as user device 420 or user device 702, for example. User interface 900 may be incorporated into a system interface or enterprise management interface for managing various devices, alerts, and control of devices in a building system.

User interface 900 includes a progress bar 902. Progress bar 902 may generally display a progress metric of uploading the configuration of the source device to a control system implementing the cloning sequence. Progress bar 902 may be periodically or continuously updating of the progress metric. In some embodiments, the progress metric is a percentage of the total configuration size uploaded to the control system. The progress bar 902 may graphically display a representation of the progress metric to a user for more convenient viewing. The progress bar 902 may be labelled with the associated device name or device ID of the source device.

User interface 900 also includes a progress bar 904 for each of the designated destination devices. Progress bars 904 may be assigned to each of the destination devices. Progress bars 904 may generally display a progress metric of configuring the associated destination device with the source device configuration. The progress bar 904 may graphically display a representation of the progress metric to a user for more convenient viewing. The progress bar 904 may be labelled with the associated device name or device ID of the source device. In some embodiments, the progress metric is a percentage of the total configuration size uploaded to the destination device. In some embodiments, the progress metric is a percentage of the total eligible configuration size versus the total uploaded to the destination device. Progress bars 904 may be sequentially updated such that a first destination device is configured before a second destination device begins the cloning process. Progress bars 904 may be periodically or continuously updating of the progress metric.

User interface 900 may also include a progress completion message 906. Progress completion message 906 may generally update the user of the status of the entire cloning operation. In some embodiments, the progress completion message 906 is a text message indicating whether the cloning sequence is complete, in progress, or in error. In some embodiments, the progress completion message 906 is a graphical icon, such as check mark to indicate completion, an ‘x’ to indicate an error, and a dash to represent in-progress. Other indications and combinations thereof may be used to indicate the progress of the cloning operation to the user.

User interface 900 also includes button 908. Button 908 may change the graphical user interface displayed to a user responsive to being selected by the user, such as returning to a home screen or graphical user interface 800. In some embodiments, button 908 may be used by the user to pause or cancel the cloning operation.

### Configurations of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method operations can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A building system configured to copy a configuration of a first controller to a second controller, the building system comprising a processing circuit configured to:
receive, via a user interface, a selection of the first controller from a plurality of source controllers and the second controller from a plurality of eligible destination controllers, wherein the user interface includes a first element providing an indication of the plurality of source controllers and a second element providing an indication of the plurality of eligible destination controllers, the plurality of eligible destination controllers being compatible with the configuration of the first controller;
receive a first instruction to copy the configuration of the first controller to the second controller;
retrieve the configuration of the first controller, the configuration defining a first set of properties of the first controller and corresponding values of the properties;
determine a mapping of the first set of properties to a second set of properties associated with the second controller; and
send a command to the second controller, the command comprising a second instruction to configure the second set of properties with the corresponding values of the first set of properties according to the determined mapping.

2. The building system of claim 1, wherein the first set of properties and the second set of properties include at least one of a data type, controller setpoint, object data structure, or control scheme.

3. The building system of claim 1, wherein the processing circuit is configured to determine the second controller is compatible to be a clone of the first controller.

4. The building system of claim 1, wherein the second set of properties is different than the first set of properties.

5. The building system of claim 1, wherein the processing circuit is configured to communicate with the first controller and the second controller via a universal communication protocol.

6. The building system of claim 1, wherein the configuration is further defined by a model, and wherein properties in the first set of properties are associated with the object model.

7. The building system of claim 6, wherein to determine the second set of properties the processing circuit is configured to generate an instance of the model for the second controller.

8. The building system of claim 1, wherein the received first instruction is based on a user input indicating an identity of the first controller and the second controller.

9. The building system of claim 1, wherein the first controller and the second controller are different controller models.

10. A building management system (BMS) comprising:
a network interface configured to communicate with a first controller and a second controller in a building system; and
a processing circuit comprising a processor and a memory with instructions stored thereon that, when executed by the processor, cause the processor to:
receive, via a user interface, a selection of the first controller from a plurality of source controllers and the second controller from a plurality of eligible destination controllers, wherein the user interface includes a first element providing an indication of the plurality of source controllers and a second element providing an indication of the plurality of eligible destination controllers, the plurality of eligible destination controllers being compatible with a configuration of the first controller;
receive a first instruction to copy the configuration of the first controller to the second controller;
retrieve the configuration of the first controller, the configuration defining a first set of properties of the first controller and corresponding values of the properties;
determine a mapping of the first set of properties to a second set of properties associated with the second controller; and
send a command to the second controller, the command comprising a second instruction to configure the second set of properties with the corresponding values of the first set of properties according to the determined mapping.

11. The BMS of claim 10, wherein the first set of properties and the second set of properties include at least one of a data type, controller setpoint, object data structure, or control scheme.

12. The BMS of claim 10, wherein the processor is further caused to determine the second controller is compatible to be a clone of the first controller.

13. The BMS of claim 10, wherein the second set of properties is different than the first set of properties.

14. The BMS of claim 10, wherein the network interface is based on a universal communication protocol.

15. The BMS of claim 10, wherein the first instruction is received from a user via a graphical user interface.

16. The BMS of claim 10, wherein the first controller and the second controller are produced by different vendors.

17. A method, comprising:
receiving, via a user interface, a selection of a first controller from a plurality of source controllers and a second controller from a plurality of eligible destination controllers, wherein the user interface includes a first element providing an indication of the plurality of source controllers and a second element providing an indication of the plurality of eligible destination controllers, the plurality of eligible destination controllers being compatible with the configuration of the first controller;
receiving an indication to clone configuration data of the first controller to the second controller;
retrieving the configuration data of the first controller, the configuration data defining a first set of properties of the first controller and corresponding values of the properties;
determining a mapping of the first set of properties to a second set of properties associated with the second controller; and
sending a command to the second controller, the command comprising an instruction to configure the second set of properties with the corresponding values of the first set of properties according to the determined mapping.

18. The method of claim 17, further comprising determining the second controller is compatible to be a clone of the first controller.

19. The method of claim 17, wherein the first set of properties and the second set of properties include at least one of a data type, controller setpoint, object data structure, or control scheme.

20. The method of claim 17, wherein the second set of properties is different than the first set of properties.
